(19) United States
(12) Patent Application Publication
(10) Pub. No.: US 2005/0122315 A1
(43) Pub. Date: Jun. 9, 2005

(54) Communications device and supporting network

(76) Inventors: Martin Chalk, North Sydney (AU); Peter Maher, North Sydney (AU); Jamie Fenton, Redfern (AU); Kevin Whitley, Redfern (AU); Peter Harrison, Bonnet Bay (AU)

Correspondence Address: STITES & HARBISON PLLC, 1199 NORTH FAIRFAX STREET, SUITE 900, ALEXANDRIA, VA, 22314, US

(21) Appl. No.: 10/495,640

(22) PCT Filed: Nov. 16, 2002
(86) PCT No.: PCT/AU02/01548

(30) Foreign Application Priority Data
Nov. 16, 2001 (AU) PR 8928
Sep. 25, 2002 (AU) 2002 951671

(51) Int. Cl. G09G 5/00

(52) U.S. Cl. 345/173

(57) ABSTRACT

An electronic hand held communications and data storage device (10) capable of sending and receiving small packets of data; the device including a display (13) capable of displaying said data, user control means (14) to enable sending and receipt of said information; wherein, the control means (14) is disposed within a field defined by the display (13). The control means (14) is arranged to allow a user a capability to pre determine commands for device function initiation.

### BACKGROUND OF THE INVENTION

This invention relates to hand held communication devices and, in particular, to a small self powered personal data storage and communication device capable of storing, sending and receiving packets of preset text, pictorial information or the like, such as names images, phone numbers, email addresses, greetings and messages etc. The invention further relates to means for operation of and navigation through device functions.

### PRIOR ART

There are in existence a wide variety of hand held devices for storage of data and which are capable of down loading or uploading data between compatible electronic devices. Examples of these devices are personal organizers, hand held computers' calculators, mobile phones, measuring instruments and remote controllers for audio. These are effective in receiving and down or uploading data and in limited processing activities. They are generally key or stylus operated but must be a minimum size dictated by the screen size.

The size of known devices is also limited by ergonomics of manual use which sets predetermined minimum dimensions for the display and particularly the method of key entry and navigation. Smaller devices than the PDA's are known but as devices become smaller there may be compromises to functionality. An example of this is the hand held game device These devices usually include a small casing which houses a screen and includes a power supply, electronics control buttons. The buttons allow a player to operate the device functions and are usually located remote from the screen and usually at the sides or below the screen. The buttons must be spaced sufficiently to allow the users finger to operate one button only at a time but the need to space the button for ergonomic advantage places limits on the minimum size possible for the device. If the buttons are too close to the screen, the users finger may partially obscure the screen. There are however devices which rely on screen pressure to active the device using a touch screen. These may be overlaid over the screen but suffer from the problem that the screen display is partially obscured.

An example of a prior art electronic data receiving device is disclosed in GB 2 299302 which teaches a device including a casing, a display screen and a touch sensitive panel which faces away from the user when the display screen faces the user. The touch panel preferably, may be variable with respect to the screen display, and may be sensitive to contact or proximity of the users finger. According to the invention disclosed in that patent, the user has an uninterrupted view of the screen because the device is operated from the back by pressure with a users finger. The device may be operable using thumbs on top and fingers underneath. GB 2 299 302 specifically teaches the use of buttons proximity switches which are adjacent or underneath but not superimposed over the display screen. In fact GB 2 299 302 teaches away from using operating means superimposed on a device screen. This approach results in an increase in the physical size of the device as there must be room for the screen and also room for the buttons, pressure sensitive panels or proximity switches remote from the screen.

Another known device is disclosed in U.S. Pat. No. 6,049,796, which teaches a method of searching data on a personal digital assistant having an input means, file storage means, a data base, a search engine, display and electronic communication means. The device described is essentially a personal organiser which a user operates by activating search keys remote from the screen. The device is relatively large within the context of hand held devices and has a high storage capacity. As the function/search keys are remote from the screen display this contributes to the physical size of the organiser. The device does not teach the use of a sequence of inputs applied to a screen in order to reduce the size of a device for hand held use.

Other known hand held devices allow transmission of text messages. Text messaging is extremely popular within certain sections of the community and is usually conducted using the mobile or cellular phone network with the users' phone handsets being the usual mode of sending and receiving the messages. The prior art teaches all of the above functions in hand held devices such as mobile phones linked to a cell network. In the case of mobile phones the messaging is effected by use of buttons which operate screen functions. The smallest prior art hand held devices have a minimum size dictated by the size of the screen display and the means to operate the device and enter and process data. These functions of display and operation are usually separate and necessitate a presentation surface area which can accommodate each facet of display and operation. This increases the overall size of the device.

### INVENTION

The present invention provides an alternative to the known hand held devices which is as small as is ergonomically possible.

It is an object of the present invention to provide a communications device which can be used to send and receive small packets of preset information. At the very least, the invention provides an alternative to presently known devices and which is capable of being manufactured small enough to a combine display and operation functions in the display field.

According to the invention there is provided a hand held device which takes the form of a small simple self powered personal terminal which can be used to send and receive small packets of preset information between compatible devices and which is capable of exchanging personal information or messages in a simple manner via screen pressure navigation of a type which triggers a mechanical or electronic action. The mechanical action may be a screen flexure, deflection or the like, wherein such mechanical energy may be converted into an electronic signal.

According to one embodiment of the present invention there is disclosed a communication device for sending and receiving preset data to and from other like devices, said device including a wireless input/output port means for sending and receiving said preset data, a link means to connect said device to a source device to download said preset data from the source device, a storage means for storing preset data to be sent and data received, a display means for displaying preset data to be sent and data received, control means for controlling functions of said device, switch means for activating the functions of said device, and power means used to operate the device, wherein said device when activated is adapted to send and receive said preset data via said input/output port when in close proximity to another said device characterized in that the control means for controlling functions of the device is disposed within the display field.

In its broadest form the present invention comprises:
an electronic hand held portable communications and data storage device capable of sending and receiving small packets of information or data, the device including a
display capable of displaying said data, user control means to enable sending and receipt of said information; wherein, the control means is disposed within a field defined by the boundaries display.

In another broad form the present invention comprises:
an electronic hand held communications and data storage device capable of sending and receiving small packets of information or data; the device including a display capable of displaying said data, user control means to enable sending and receipt of said information; wherein, the control means is disposed within a field defined by the display.

Preferably, said control means is arranged to allow a user a capability to pre determine commands for device function initiation. According to one embodiment, a user operates device functions by a predetermined sequence of mechanical inputs.

Preferably the device includes; a data input/output port, link means associated with the display for transmission of preset data to and/or from a remote device; wherein said display includes means to process, transmit and receive data displayed on a screen comprising said display.

The communications device communicates with at least one remote source of said data located in said remote device and which is capable of uploading data to or receiving downloaded data from said remote source. The device further comprises;
a storage means for storing preset readable data to be sent from and received by said communications device; the device further comprising; an LCD display forming a screen which displays said data Preferably device functions are performed by a user interface on said screen. The user interface is preferably actuated by hand pressure on said screen, which induces a mechanical action such as flexure or deflection which activates an electronic signal.

The device when activated is adapted to send and receive a text message via said input/output port means when in close proximity to said remote device.

In another broad form the present invention comprises:
an electronic hand held communication and data storage device capable of sending and receiving preset data to and from another compatible remote source device, wherein said communication device includes;
an input/output port,
an LCD display for displaying said data,
means for transmission of said preset data to and/or from said remote device;
wherein said LCD display screen includes link means to process, transmit and receive data displayed on said LCD screen;
a communication means to connect said device to a remote source device to download said preset data from the source device or upload said preset data to said source device;
a storage means for storing preset data to be sent and received,
a display means for displaying preset data to be sent and received,
wherein functions performed by the communications device are activated by a screen user interface. The user interface comprises screen pressure inducing a mechanical screen flexure or deflection which initiates an electronic signal.

Functions performed by said device are activated by a predetermined sequence of pressure activated clicks on the LCD display.

The device is preferably programmable with an individual unique operator sequence which enables an operator to navigate through device functions. The device is programmable for operation with or without an access code or password and may communicate with a remote computer, kiosk network of machines such as a vending machine which may form a part of a wider network. The device may be wireless usingan IR port, bluetooth or other wireless method.

In another broad form the present invention comprises:
a hand held self powered communications device capable of sending and receiving packets of preset information or data between at least one compatible device;
wherein transmission of said information and navigation through functions performed by said device is enabled by a screen by application of screen pressure which initiates an electronic signal. The screen pressure induces a screen flexure or deflection inducing said electronic signal.

In another broad form the present invention comprises:
a hand held communications device for sending and receiving preset data to and from other like devices, said device including an input/output port means for sending and receiving said preset data, a link means to connect said device to a source device to download said preset data from the source device, a storage means for storing preset data to be sent and data received, a display means for displaying preset data to be sent and data received, control means for controlling functions of said device, switch means for activating the functions of said device, and power means used to operate the device, wherein said device when activated is adapted to send and receive said preset data via said input/output port when in close proximity to another said device characterized in that the control means for controlling functions of the device is disposed within the display field. According to one embodiment, a user may program into the device an individual unique operator sequence which enables that operator to navigate through device functions.

In another broad form of a method aspect the present invention comprises:
a method for operating an electronic hand held communication and data storage device capable of sending and receiving preset data to and from another remote source device, the hand held device including an LCD display for displaying said data,
the method comprising the step of;
applying mechanical manual action to said LCD display in a predetermined sequence and in at least one predetermined location on the display to navigate through data paths and manipulate data via a menu on the screen display;
wherein said communication device includes;
an input/output port;
means for sending said preset data to said remote device;
wherein the operator may read data on the screen and process, down load, upload or otherwise manipulate said data by applying said pressure to said LCD display.

In another broad form the present invention comprises;
an electronic hand held communication and data storage device capable of sending and receiving preset data to and from another compatible remote source device, wherein said communication device includes;
an input/output port,
an LCD display for displaying said data,
means for transmission of said preset data to and/or from said remote device;
wherein said LCD display screen includes link means to process, transmit and receive data displayed on said LCD screen;
a communication means to connect said device to a remote source device to download said preset data from the source device or upload said preset data to said source device;
a storage means for storing preset data to be sent and received,
a display means for displaying preset data to be sent and received,
wherein functions performed by the communications device are activated by pressure creating the aforesaid mechanical action including screen flexure, deflection or the like, wherein such mechanical energy may be converted into an electronic signal;
wherein the screen provides a user interface; and
power means used to operate the device, wherein said device when activated is adapted to send and receive said preset data via said input/output port means when in close proximity to said remote device.

According to a preferred embodiment, the user may program into the device an individual unique operator sequence which enables that operator to navigate through all paths. Preferably, to allow the device to be used as a personal identification device such as in the case of an emergency there are provided a non barred sequence capable of use by any user of the device without an access code or password.

According to an alternative embodiment, the remote device is a like communications device. Communications with said remote device may be by wire or wireless communications such as but not limited to infra red.

Preferably, the input/output port means is an IR port, however other types of wireless connecting ports/interfaces are able to be used such as but not limited to Bluetooth

In another broad form the present invention comprises:
an electronic hand held communication and data storage device capable of sending and receiving preset data to and from another remote source device, wherein said communication device includes,
an input/output port,
an LCD display for displaying said data,
means for sending said preset data to said remote device;
characterized in that the LCD screen includes at least one operating station allowing a user to read and navigate through available data paths initiated via a menu and independently process, down load upload or otherwise manipulate said data displayed on the screen via the operating station/s.

In another broad form of a method aspect the present invention comprises;
a method for operating an electronic hand held communication and data storage device capable of sending and receiving preset data to and from another remote source device, the hand held device including an LCD display for displaying said data,
the method comprising the step of;
applying mechanical manual action to said LCD display in a predetermined sequence and in at least one predetermined location on the display to navigate through data paths and manipulate data via a menu on the screen display;
wherein said communication device includes;
an input/output port;
means for sending said preset data to said remote device;
wherein the operator may read data on the screen and process, down load, upload or otherwise manipulate said data by applying said pressure to said LCD display.

Preferably, said LCD display screen includes link means to process, transmit and receive data displayed on said LCD screen and to connect said device to a remote source device to download said preset data from the source device, a storage means for storing preset data to be sent and data received, a display means for displaying preset data to be sent and data received, wherein functions performed by the communications device are activated by a mechanical action which may be a screen flexure, deflection or the like, wherein such mechanical energy may be converted into an electronic signal;
wherein the screen provides a user interface; and
power means used to operate the device, wherein said device when activated is adapted to send and receive said preset data via said input/output port means when in close proximity to another said device.

Preferably device operation is via a pattern, sequence or series of clicks on the display screen, which enable manipulation, transmission and processing of screen data. In one non limiting embodiment, sites of pressure operation are the points of the compass and centre of screen. The click or pressure sequence may comprise one or more clicks on the LCD screen at one or more locations of said screen. The number of clicks for a particular operation may be adjusted via a quick click option in the set up software. This enables a user to set a particular click sequence to navigate a particular feature path. With this option, the user may introduce personalized shortcuts for selected functions to avoid traversing through multiple screens to a destination.

In another broad form of a method aspect the present invention comprises;
a method for operating an electronic hand held communication and data storage device capable of sending and receiving preset data to and from another remote source device, the hand held device including an LCD display for displaying said data,
the method comprising the steps of;
a) setting via enabling software, a predetermined number of navigational clicks for a particular operation thereby enabling a user to set a particular click sequence or shortcut to navigate a particular feature path,
b) applying pressure to said LCD display in a predetermined sequence and in at least one predetermined location on the display to navigate through data paths and manipulate data via a menu on the screen display;
wherein said communication device includes;
an input/output port;
means for sending said preset data to said remote device;
wherein the operator may read data on the screen, down load, upload or otherwise manipulate said data by applying said pressure to said LCD display.

In a preferred form, the link means comprises an interface lead that is adapted to be connected to a standard PC or the like. This link can also be a wireless connection if suitable. The preset data is preferably formed in the PC or the like by suitable software, such as a custom software suite downloaded from an internet website. Thus a purchaser of the device would need to use operating enabling software that may accompany the device or be downloaded via the Internet.

Preferably, the preset data includes a user ID primary message such as name, phone number, email address, etc. Some fields such as identification of the owner of the device may be accessible by any user ( once enabling software has been utilised ) but without access codes or pass words. The software preferably limits access to all fields without an access code or password.

The preset data may also include a number of alternative message options in either text or icon form.

Preferably, the display means and control means are adapted to allow scrolling through stored messages. Preferably, the switch means is a screen interface which allows a user to actuate all the control functions of the device by screen/LCD interaction.

Preferably, the device power means is a battery device such as a one time use button cell battery or a rechargeable battery that can be recharged via the link means or to a standard power recharger. Preferably an ON/OFF switch is provided.

### BRIEF DESCRIPTION OF THE DRAWINGS

The present invention will now be described in more detail according to a preferred embodiment and with reference to the accompanying illustrations wherein;

FIG. 1 a is a front view of a communication device according to one embodiment of the present invention;

FIG. 1b is a side view of a communication device according to one embodiment of the present invention;

FIG. 1c is a rear view of a communication device according to one embodiment of the present invention.

FIG. 2 a is a front view of a communication device according to an alternative embodiment of the present invention;

FIG. 2b is a side view of a communication device according to an alternative embodiment of the present invention;

FIG. 2c is a rear view of a communication device according to an alternative embodiment of the present invention.

FIG. 2d is a cross section view taken through X-X of FIG. 2c with screen disposed horizontally.

FIG. 2d is a cross section view taken through X-X of FIG. 2c with screen disposed in response to user actuation.

FIG. 3 shows the device with blank screen and screen lock and unlock facility.

FIG. 4a-c show steps in security entry according to one embodiment.

FIGS. 5a-c show steps for a user to send preset IDs according to one embodiment.

FIGS. 6a-d show steps for owner to send messages according to one embodiment.

FIGS. 7a-d show an example quick click navigation regime which allows a user to activate pre-chosen options for sending and receiving IDs.

FIGS. 8a-c show three displays for a contact look up.

FIGS. 9 a-c show three displays for receiving an ID.

### BEST MODE OF CARRYING OUT THE INVENTION

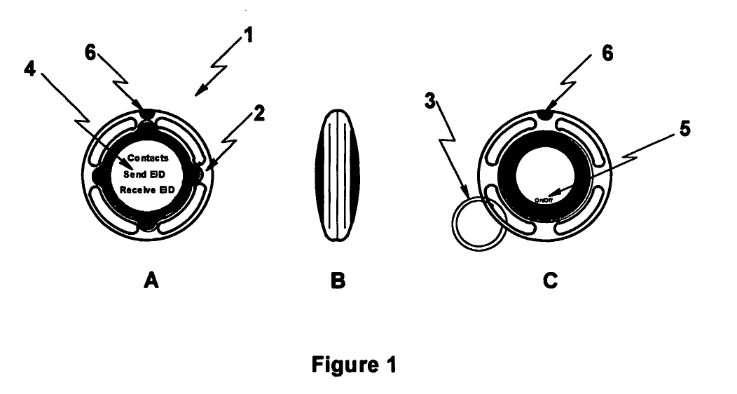

FIG. 1a shows a personal communication device 1 according to a preferred embodiment which is small, simple, self powered and which sends and receives small packets of preset text message information such as name, phone number, email address, etc. The communication may be wireless or wired.

FIG. 1b is a side view of the communication device of FIG. 1a and FIG. 1c is a rear view of the communication device of FIG. 1a.

The device 1 according to one embodiment is a pocket sized or smaller about, but not limited to 40 mm diameter, which can be held in the hand worn on a belt as a pendant, kept on a key ring or in a handbag. The housing 2 of the device 1 may be, disc shaped as shown, with a shackle 3 ( see FIG. 1c) for connection to a belt, pendant, key ring etc. It will be appreciated that the device according to the invention may be manufactured in a variety of non limiting shapes.

The device 1 includes within the housing 2 which may be made of soft rubber, a memory storage, a simple controller and preferably a one time use or rechargeable button cell battery. The device is operated by user interaction with LCD display 4. An ON/OFF switch 5 which may also be incorporated in the screen operation, is used to switch the device 1 off when not in use to conserve the battery life. LCD display 4 with light and has an IR port 6 for sending and receiving the signals of the text message information. The device also includes an interconnect port to interconnect the device 1 to a standard PC or like device. This interconnection is accomplished by means of a wire lead ( not shown). Device 1 is therefore simple, has control incorporated with a display screen. To set up device 1 ready for use, the user connects the device to the PC and by means of either suitable software, such as a custom software suite downloaded from an internet website, which offers a simple address book style database plus an ID primary message info menu which the user can access. The user programs the device with a user ID primary message from the custom software, or can also program in a number of alternative message options in either text or icon form.

As the messages are programmed in by the user, the messages can be purely data such as phone number or address or they can be filed and intended to either encourage or discourage continuation of a contact,

The device 1 can preferably receive, store and display up to and potentially more than 200 records which can be viewed by screen scrolling. The user can illuminate the display if in poor light. A major advantage of the present invention are the user operation features which allow display reading and data manipulation in a very small space.

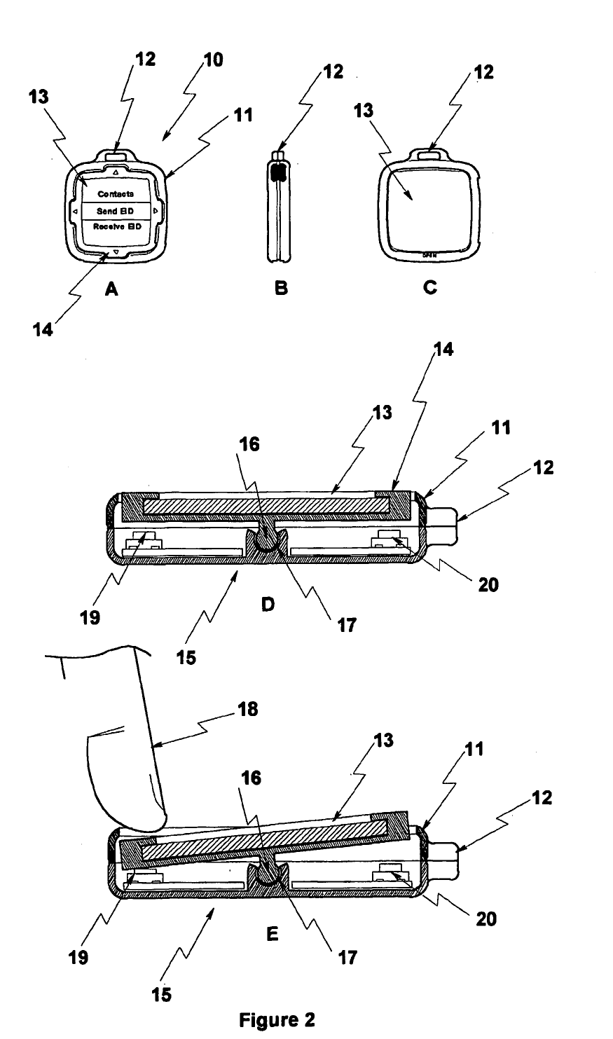

FIG. 2a is a front view of a communication device 10 according to an alternative embodiment of the present invention. FIG. 2b is a side view of the communication device of FIG. 2a. FIG. 2c is a rear view of the communication device of FIG. 2a.

The device 10 is also a pocket sized or smaller and which can be held or worn on a belt as a pendant kept on a key ring or in a handbag. The housing 11 of the device 10 may be rectangular with radiused corners and including with a shackle 12 for connection to a belt, pendant, key ring etc. It will be appreciated that device 10 according to the invention may be manufactured in a variety of non limiting shapes

The device 10 includes housing 11 which may be made of soft rubber, a memory storage, a simple controller and preferably a one time use or rechargeable button cell battery. The device is operated by user interaction with LCD display 13. An ON/OFF switch 5 which may also be incorporated in the screen operation, is used to switch the device 1 off when not in use to conserve the battery life. Device 10 includes LCD display 13, a light and an IR port 14 for sending and receiving the signals of the text message information. The device also includes an interconnect port to interconnect the device 10 by means of a wire to a standard PC or like device.

FIG. 2d is a cross section view taken through X-X of FIG. 2c with screen disposed horizontally. FIG. 2d is a cross section view taken through X-X of FIG. 2c with screen disposed in response to user actuation.

According to the embodiment shown in FIGS. 2d and 2e, screen 13 is supported in cradle 14 having an intermediate underside support which enables cradle and hence screen 13 to rock about pivot assembly 15. Pivot assembly 15 comprise a male protrusion 16 adapted for pivoting engagement within female recess 17. As screen rocks in response to pressure applied by a finger 18 of a user, this mechanical action is converted into rotation by cradle 14 which then engages button 19. Likewise when cradle 14 is rotated in the opposite direction by pressure applied at an opposite end of screen 13, this causes cradle to engage button 20. The device may be programmed so that a predetermined number of clicks will cause a predetermined function to occur. The screen effectively rocks and simulates a toggle or rocker switch. Actuation of buttons 19 and 20 may be effected by alternative means to that shown.

According to one embodiment, a user interface is effected by a series or sequence of Morse code like navigation steps which may employ North, South, East, West (Compass point) navigation. The navigation may be achieved by a series of clicks on the LCD display 4 which enables the user to press the screen at predetermined locations to move through devices features. Also, navigation regimes may be either factory or user pre programmed into the device or altered via the screen input. The user can define via the PC software the “response to predetermined inputs” which provides the user wide variety of characterizing features so the device suits the users individual requirements. The User may program a security entry click sequence via compass point navigation which unlocks the device to user needed to navigate past an initial welcome screen. User can also program special navigation sequences required for selecting personal or business or other recorded data ready to send to another like device or for downloading to a compatible storage device such as a computer, or to a kiosk network with vending machines ore like peripherals capable of electronic transmission. The device may also be programmed with a sequence for receiving data. The direct screen manipulation may simulate a rocker or toggle switch which would otherwise be used as an alternative to touch-screen navigations. Thus predetermined locations on the screen provide according to one example notional compass points which assist the user in identifying precisely where to interact with the screen. The compass points provide a convenient signpost for the user interaction but it will be appreciated by persons skilled in the art that locations of the screen “switches” may be altered. Due to the combined screen display and screen navigation a suitable reduction in size of the device can be achieved which itself opens new possibilities for applications of the device. For example the device may be employed as a Luggage Tag which attached to a persons luggage as an electronic ID while travelling, as an identity tag for students back packs.

User ID data can be displayed via Welcome screen without needing ability (password sequence) to unlock device. The device also functions as a Personal ID or emergency tag in various forms such as a key ring. A person may contact the owner in the event that the device is lost. The device may be programmed for ease of accessibility when used as an aid device or emergency data display device so it may be readily accessed by a by-stander should the owner/bearer be injured or suffer from a medical condition or be lost ( in the case of seniors with memory difficulties or a child). Emergency medical or contact details may be displayed via a Welcome screen without needing ability (password sequence) to unlock device. The device may also be employed in a communications network where the user may communicate with other users via a kiosk type network. According to one embodiment the kiosk may comprise a potentially unlimited number of readily accessible compatible machines which the device can communicate with to download or upload data. When the device is used in conjunction with a supporting communications network, users may allow the device to communicate with another device such as a vending machine or indeed any machine capable of electronic/satellite/radio wave/digital communications which is readily accessible. The vending machine will be networked and will be readily publicly accessible in much the same way as public phones. A user can download messages or other data onto the device at distributed vending machines networked to the internet.

Communication may be made by holding a pair of devices 10 so that the IR ports 16 face each other and are close enough to communicate with each other. The users then activate the send function and the data is transferred by the IR signal. The device may be used to exchange details when users meet other users in social or business situations. As an example the device may be used to exchange business cards. Stored messages can be deleted or downloaded to a PC using the PC link. The device 10 can also be pre programmed to display graphic/advertising messages and can be given away as a promotional item or can be sold from a programming/dispensing station within stores, clubs, pubs, shopping malls, etc.

It can be seen that device 10 can be used to exchange personal information or preset messages with people one meets anywhere, anytime as long as those persons have a compatible device.

There are a number of advantages which derive from use of the device described herein which include the ability to;
a) store and display user contact, personal or emergency details;
b) exchange of electronic IDs, messages etc via wire or Infrared;
c) send and receive contact details between other infrared devices;
d) exchange simple messages.

The invention will now be described with reference to screens which display access and navigations regimes according to a preferred embodiment.

Each screen display shown in the figures referred to below includes at least one operating button shown for illustrative purposes, but it will be appreciated that these can be taken as illustrative of screen locations.

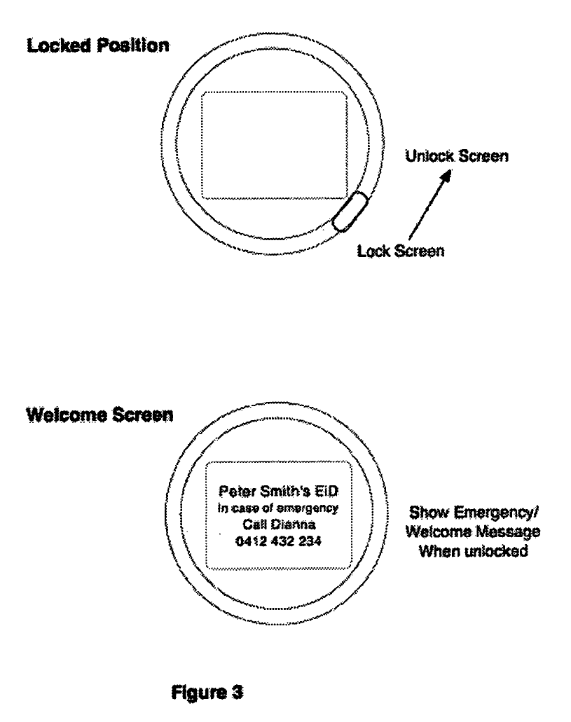

FIG. 3 shows the device with blank screen and screen lock and unlock facility. The user may block access to the device or may unlock the screen for access to welcome screen display indicia for ID and emergencies.

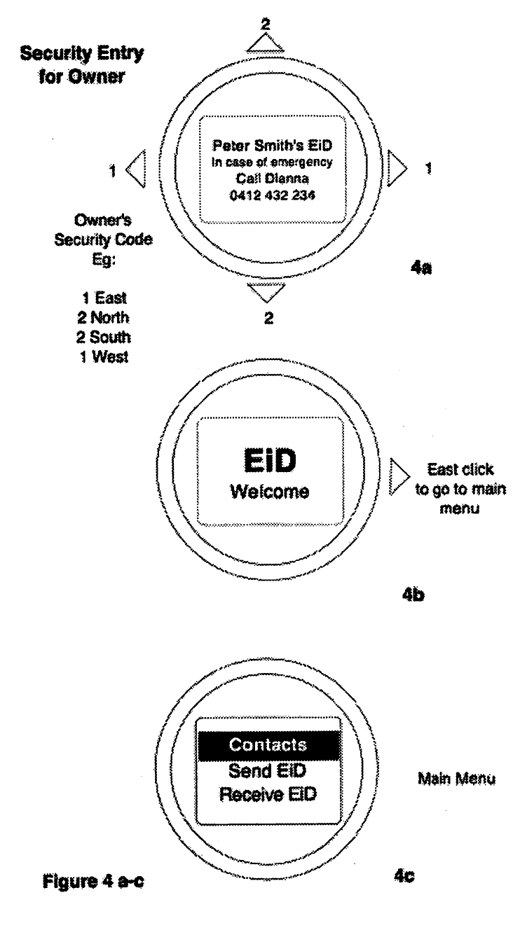

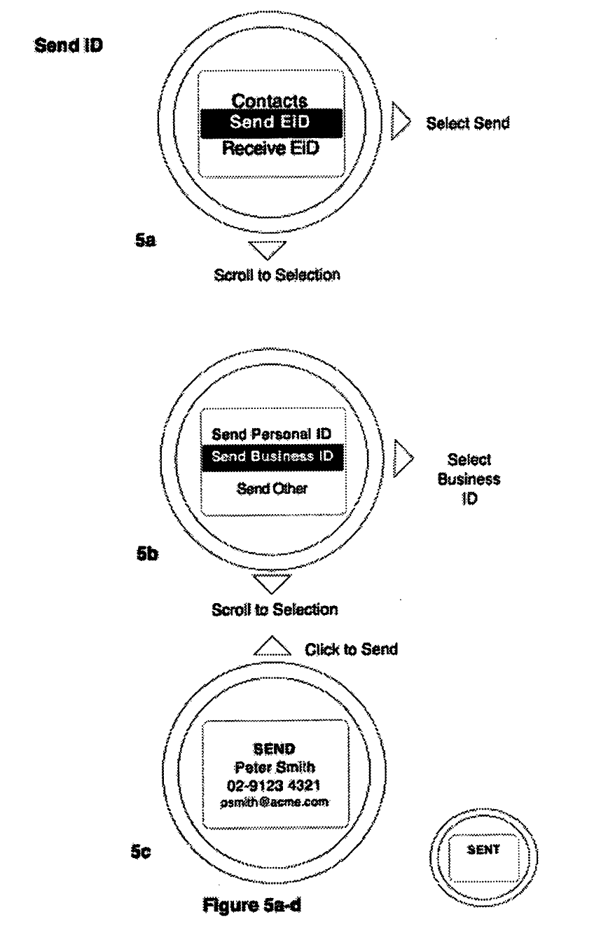

FIG. 4a-c show steps in owner security entry according to one embodiment. FIG. 3a shows a screen including a typical identity and emergency data display which is shown without the need for the users security access code. An owner then inputs a security code via a combination of clicks such as 1 East, 2 North, 2 South, 1 West. This is an example of potentially hundreds of available click combinations which may be factory or user programmed into the device for user access and/or navigation. FIG. 3b is a welcome display screen which appears after the security code has been accepted. The main menu may be presented after the Welcome screen is displayed for three seconds or similar time or by the user clicking the East button.

FIG. 5a-c show steps for owner to send preset IDs according to one embodiment. FIG. 5a shows a display screen a menu allowing a choice of contacts, send or receive options similar to FIG. 4c. Send may be selected by scrolling to that item in the menu and then pressing east button which results in screen display 5b which provides user choices of sending personal ID, business ID or send other. A south button allows scrolling through the available menu. FIG. 5c shows the use of the north button which in the case of the example shown sends business ID which may be phone, fax and Email details

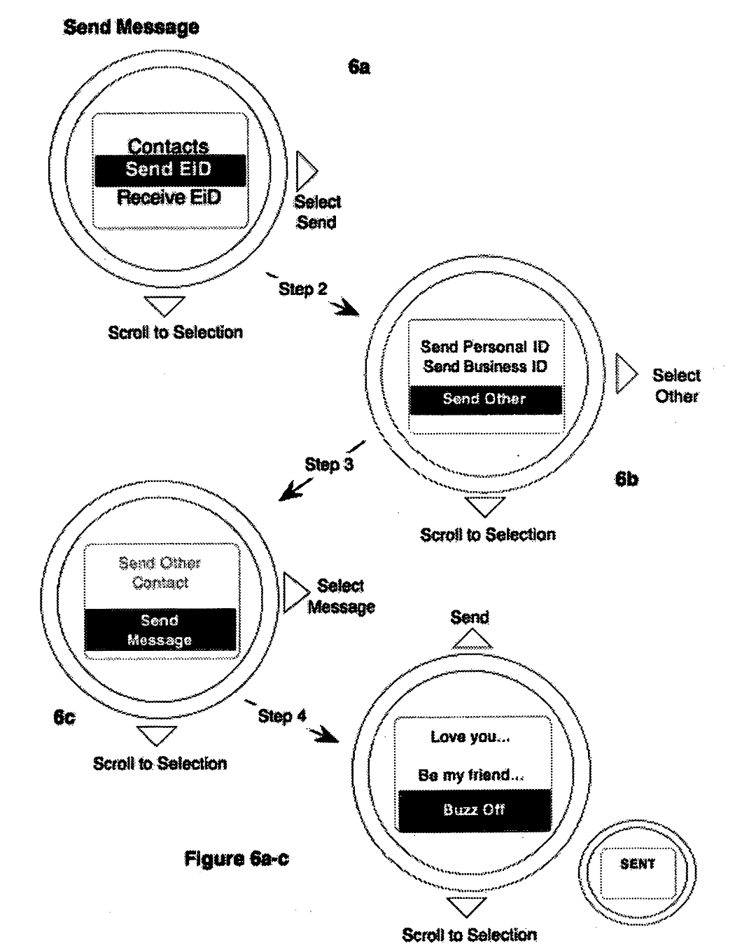

FIG. 6a-d show steps for owner to send messages according to one embodiment. FIG. 6a shows a display screen a menu allowing a choice of contacts, send or receive options similar to FIG. 5a. To send other non-ID items the user will scroll to that item using the south and north navigation buttons and then click the east button to select their choice. Further choices are available as shown in display 6b which provides user choices of sending personal ID, business ID or send other. In the display of FIG. 6b “send other” has been selected. Right clicking on the select other button causes presentation of screen 6c. A south button allows scrolling through the available menu ‘send other contact”. A select button allows a user to choose send message. FIG. 6d includes a north send button which in the case of the example shown sends a short text message.

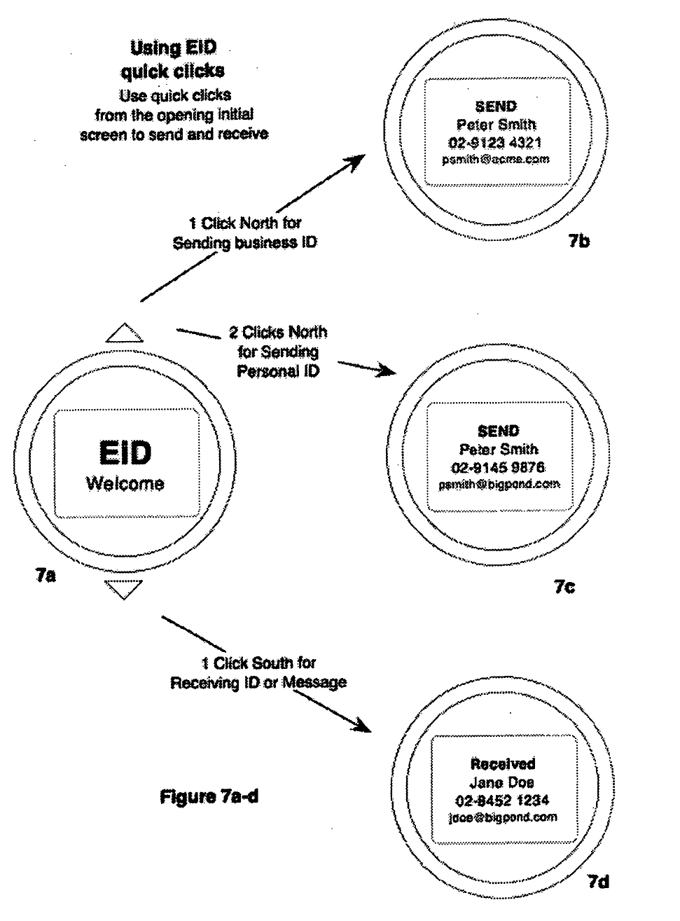

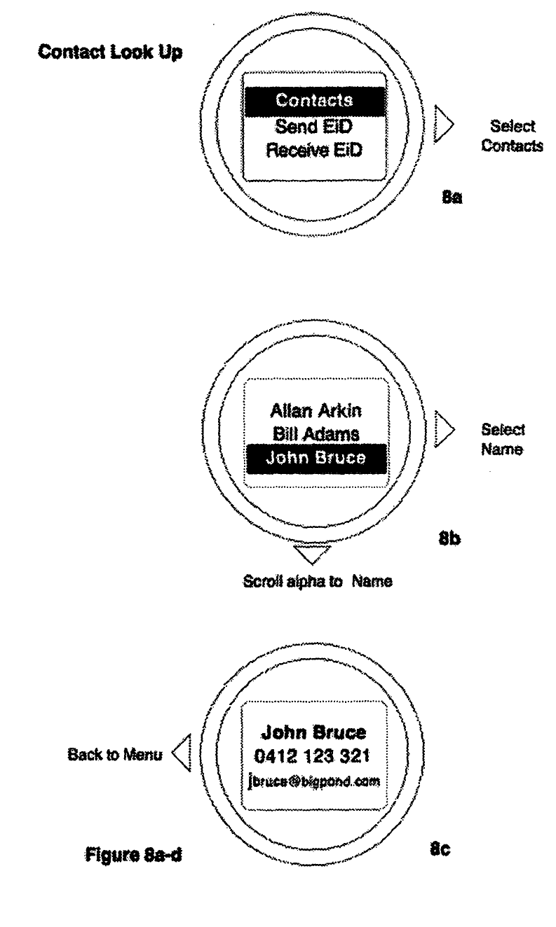

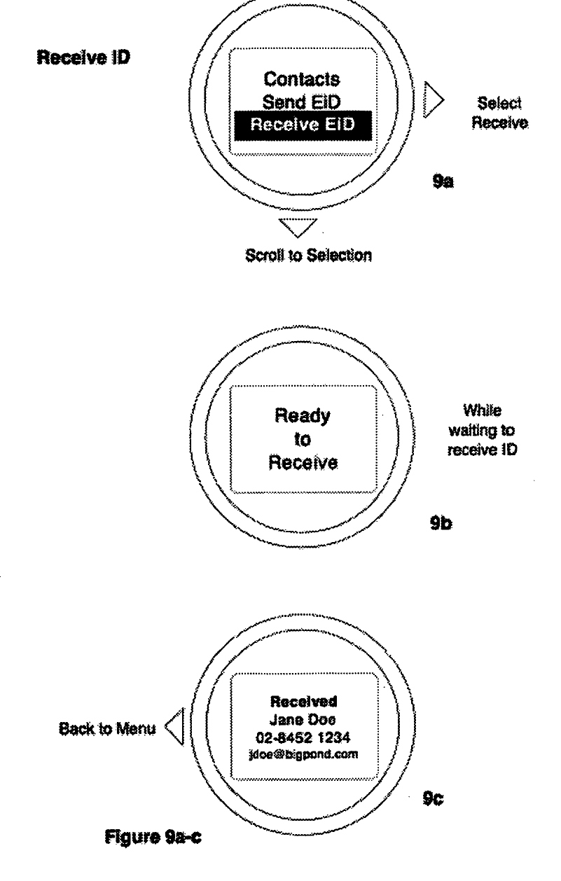

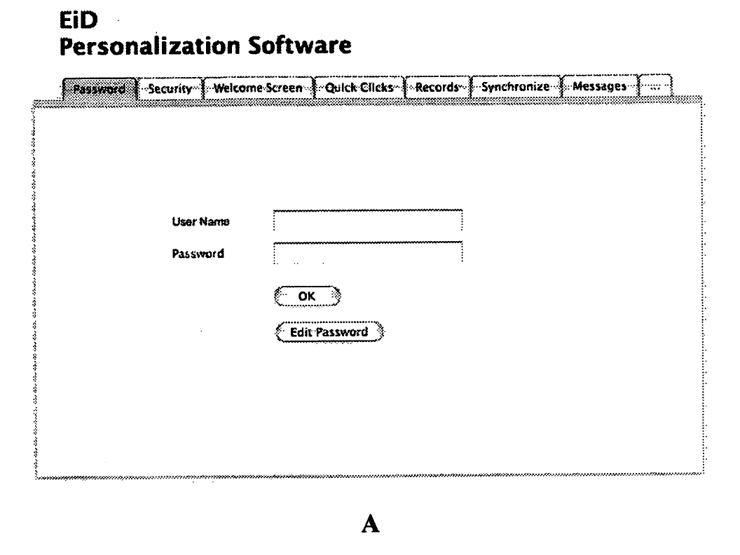

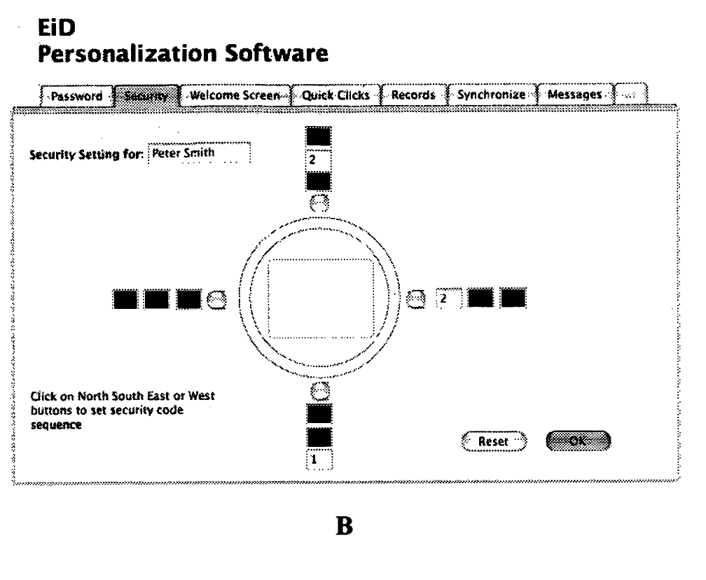

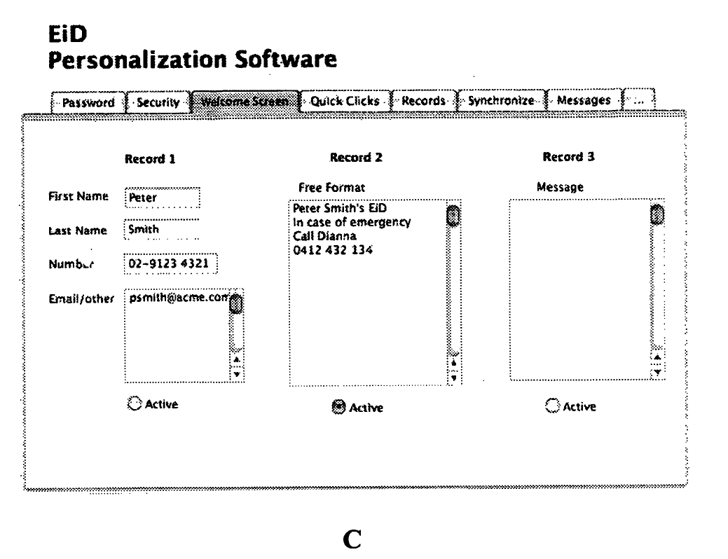

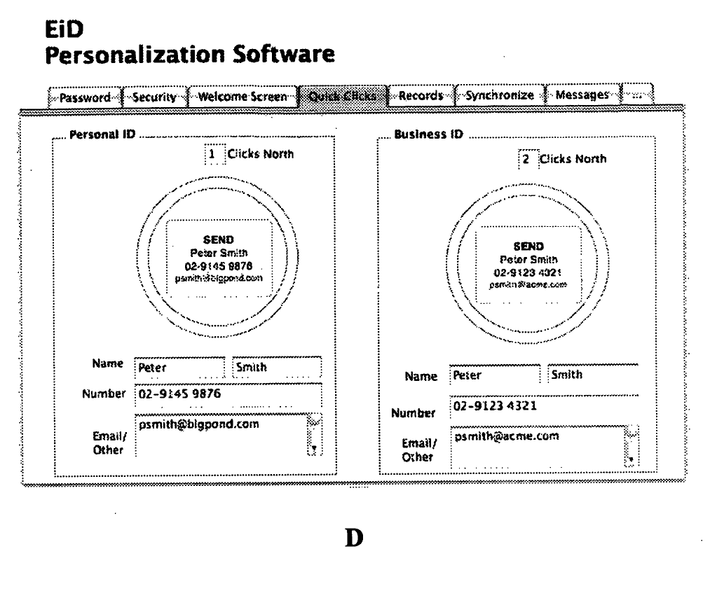

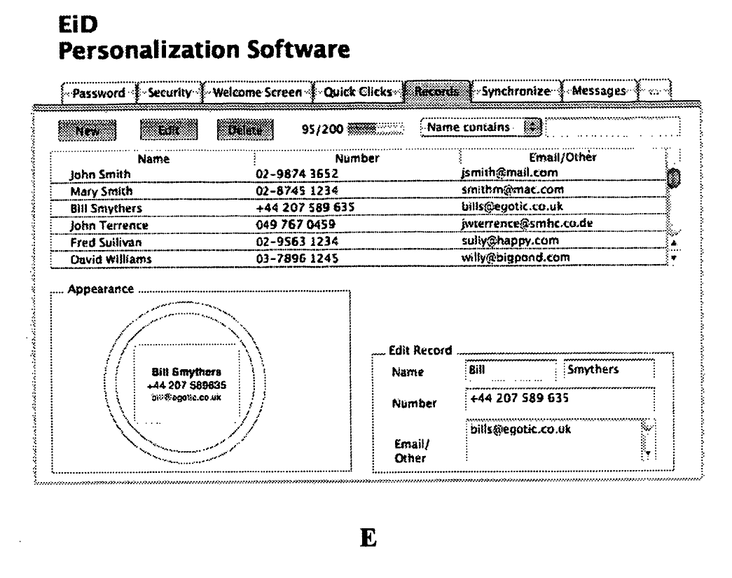

Referring to FIGS. 7a-d there is shown an example quick click navigation regime which allows a user to activate pre-chosen options for sending and receiving IDs. FIG. 7a displays a welcome screen available once the security code of the user is accepted. The device may be set so that one or two clicks north for instance will enable a quick view and sending of a user ID. In another embodiment a single south click will allow the device to receive an ID or message from a compatible device. The user may program the device for a particular click regime (eg 1 click, 2 clicks, 3 clicks etc) which navigates to an end screen directly or via intermediate screens. This allows speedy navigation through a predetermined path. These are further shown in screenshots D.

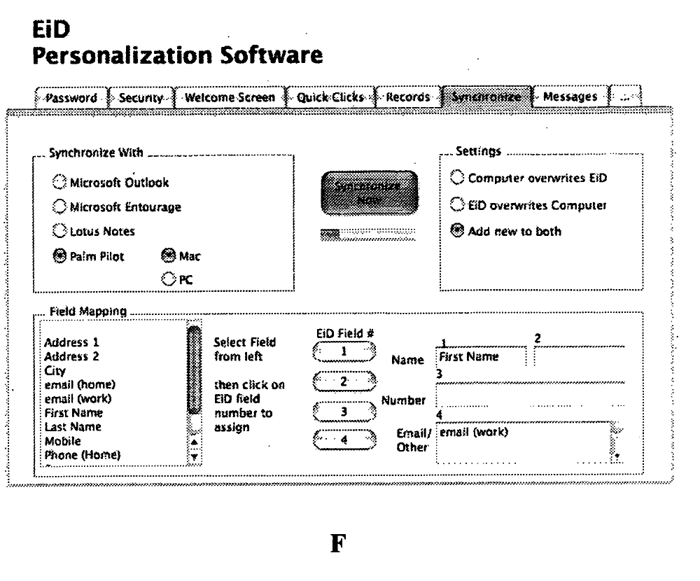

FIGS. 8a-c show three displays for a contact look up. The main menu is accessed according to the regime described with reference to FIGS. 4a-c, where FIG. 4b is a welcome display screen which appears after the security code has been accepted and 4c is a main menu screen. A contact selection is made and a list of contacts are displayed which can be scrolled via north and south navigation buttons, as in FIG. 8b. A particular contact is selected with an east click whereupon the contact is displayed as shown in FIG. 8c.

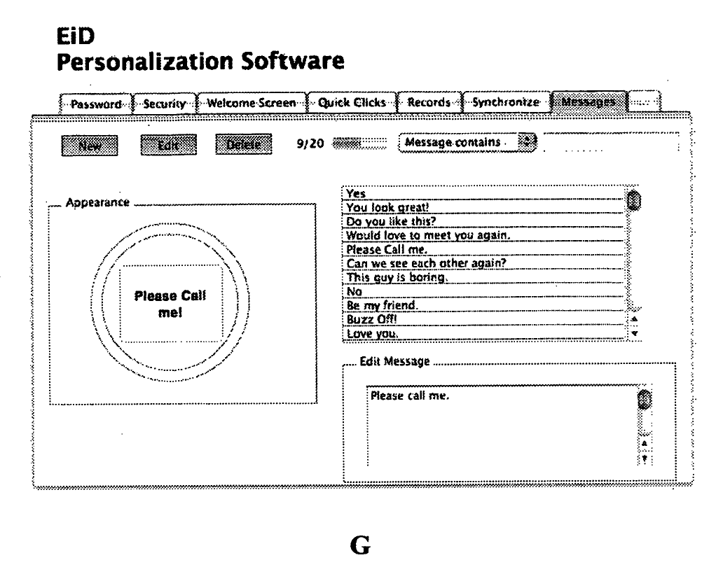

FIGS. 9a-c show three displays for receiving an ID. The main menu is accessed according to the regime described with reference to FIGS. 4a-c, where FIG. 4b is a welcome display screen which appears after the security code has been accepted and 4c is a main menu screen as for FIG. 9a. A selection of receive ID is made by the user which initializes a “ready to receive screen” as in FIG. 9b while waiting to receive ID. Screen 9c displays a received ID. The user may navigate by west click from here back to the main menu of FIG. 9a.

Device Software

Screen shots A-G listed below show possible user and security set up options for effective set up operation for the device via enabling software to be used on a PC or PDA.

A Pass word

B Security code/s input

C Welcome Screen

D Quick Clicks

E Records Screen

F Synchronize with compatible Device.

G Messages data base

The hand held device includes its own enabling software and additional software for synchronization with a compatible device such as but not limited to a palm pilot or PC. The device may also be synchronized with proprietary software such as but not limited to a Microsoft Outlook program. Personal user software includes a number of functions for both set up and user operation. Set up options include password, security and synchronization.

A typical password set up option will be related to a compass point code set up. The user chooses their preferred security sequence which can be a combination of one or more east, west, south and north clicks in any order. In the screenshot B the security code becomes, 1 click east, 1 click north and 1 click south in that order.

User options also include the ability to customize the welcome screen, “quick clicks” described above, and manage records for personal and business data and messages. The user may select from a variety of data fields which include for example first and last names, addresses city, state, post code and Email. Records held of other users may be loaded from a PC via a records data base directly into the device. These data fields may be loaded from another compatible data base such as from a PC although this requires synchronization by the user (see screen F). The device also allows on the LCD display system icons, images and/or text. The text may be transmitted along with icons.

The software includes a password field, which will in a typical case require insertion of a user name and password. This will normally constitute the primary barrier to unauthorized access.

A welcome screen may be set up by nominating a welcome screen option in the enabling software. According to one embodiment this may be enabled by entry into fields such as name, address and Email. Alternatively this user ID data may be inputted in a free form format which is not field dependent. The welcome screen may also have included a message, entered in a message field. The personalization software also includes a set up option to establish the aforesaid quick clicks. A predetermined click option may be set for the user's business or personal ID fields so that when a user requires a personal or business ID to be sent this may be effected by a predetermined click sequence. Thus the direct navigations or shortcuts may be effected by a single or double click for instance without the need to move through otherwise available screen options.

Finally, the user may down load standard personal text messages from compatible devices such as a PC. These may be loaded into the device individually or collectively from the parent PC or other device.

According to another embodiment, the device incorporates GPS functionality to enable the device to be located and tracked which may be used in combination with the device functions.

The foregoing describes only some embodiments of the present invention, and it will be recognized by persons skilled in the art that numerous variations and modifications may be made to the invention broadly described herein without departing from the overall spirit and scope of the invention.

1. An electronic hand held communications and data storage device capable of sending and receiving small packets of information or data; the device including a display capable of displaying said data, user control means to enable sending and receipt of said information; wherein the control means is disposed within a field defined by the display.

2. An electronic hand held communications device according to claim 1 wherein said control means is arranged to allow a user a capability to predetermine commands for device function initiation.

3. An electronic hand held communications device according to claim 2 wherein a user operates device functions by a predetermined sequence of mechanical inputs.

4. An electronic communications device according to claim 3, wherein device includes;
a data input/output port,
link means associated with said display for transmission of said preset data to and/or from a remote device;
wherein said control means allows processing, transmission and receipt of data displayed on a screen providing said display.

5. A communication device according to claim 4, wherein, said communications device communicates with at least one remote source of said data capable of uploading data to or receiving downloaded data from said remote source.

6. A communications device according to claim 5 further comprising:
a storage means for storing preset readable data to be sent from and received by said communications device; and wherein the screen is an LCD.

7. A communications device according to claim 6 wherein functions performed by the communications device are accomplished by a user interface on said screen.

8. A communications device according to claim 7 wherein the user interface is actuated by hand pressure on said screen.

9. A communications device according to claim 8 wherein said finger or thumb pressure on said screen induces a mechanical action which activates an electronic signal.

10. A communications device according to claim 9 wherein the mechanical action includes a screen response to user pressure.

11. A communications device according to claim 10 wherein said screen response is flexure or deflection of a screen surface.

12. A communications device according to claim 11 wherein the screen in response to user pressure engages at least one actuating button.

13. A communications device according to claim 12, wherein the device further comprises;
power means used to operate the device, wherein said device when activated is adapted to send and receive said preset data via said input/output port means when in close proximity to said remote device.

14. A communications device according to claim 3 wherein said data comprises a message to or from said remote device.

15. A communications device according to claim 14 wherein said message is text.

16. A communications device according to claim 15 wherein the device communications protocol is blue tooth.

17. An electronic hand held communications and data storage device capable of sending and receiving preset data to and from another compatible remote source device, wherein said communication device includes;
an input/output port,
an LCD display for displaying said data,
means for transmission of said preset data to and/or from said remote device;
wherein said LCD display screen includes link means to process, transmit and receive data displaced on said LCD screen;
a communication means to connect said device to a remote source device to download said preset data from the source device or upload said preset data to said source device;
a storage means for storing preset data to be sent and received,
a display means for displaying preset data to be sent and received,
wherein functions performed by the communications device are activated by control means incorporating a screen/user interface located within a boundary defined by said screen.

18. An electronic hand held communications device according to claim 17 wherein said control means is arranged to allow a user a capability to predetermine commands for device function initiation.

19. An electronic hand held communications device according to claim 18 wherein a user operates device functions by a predetermined sequence of mechanical inputs.

20. A communications device according to claim 19 wherein said screen user interface comprising said screen pressure inducing a mechanical screen flexure or deflection which initiates an electronic signal.

21. A communications device according to claim 20 further comprising a power source to operate the device; wherein, said device when activated, is adapted to send and receive said preset data via said input/output port means when in close proximity to at least one said remote device.

22. A communications device according to claim 4 wherein functions performed by said device are activated by a predetermined sequence of pressure activated clicks on the LCD display which activate at least one command button beneath said screen.

23. A communications device according to claim 22 wherein the device is user programmable with an individual unique operator sequence which enables an operator to navigate through device functions.

24. A communications device according to claim 24 wherein the device is programmable for operation with or without an access code or password.

25. A communications device according to claim 24 wherein the remote device with which the hand held device can communicate is a computer, kiosk network of machines such as a vending machine which may form a part of a wider network.

26. A communications device according to claim 25 wherein, the remote device with which the hand held device can communicate is a like communications device.

27. A communications device according to claim 1 wherein communication by said device are via wire or wireless.

28. A communications device according to claim 27 wherein the input/output port means is an IR port.

29. A hand held self powered communications device capable of sending and receiving packets of preset information or data between at least one compatible device;
wherein transmission of said information and navigation through functions performed by said device is enabled by a screen by application of a mechanical input to a screen which initiates an electronic signal.

30. A hand held device according to claim 29, wherein said screen pressure induces a screen flexure or deflection inducing said electronic signal.

31. A hand held communications device for sending and receiving preset data to and from other like devices, said device including an input/output port means for sending and receiving said preset data, a link means to connect said device to a source device to download said preset data from the source device, a storage means for storing preset data to be sent and data received, a display means for displaying preset data to be sent and data received, control means for controlling functions of said device, switch means for activating the functions of said device, and power means used to operate the device, wherein said device when activated is adapted to send and receive said preset data via said input/output port when in close proximity to another said device characterized in that the control means for controlling functions of the device is disposed within the display field.

32. A communications device according to claim 24 wherein the display field is an LCD and the hand held device is activated by a predetermined sequence of pressure activated button clicks applied to the LCD display.

33. A communications device according to claim 1 wherein a user may program into the device an individual unique operator sequence which enables that operator to navigate through device functions.

34. A communications device according to claim 1 wherein device operation is via a pattern, sequence or series of clicks on the display, which enable manipulation, transmission and processing of information or data and which are preprogrammed into the device.

35. A communications device according to claim 34 wherein sites of said clicks are the points of the compass.

36. A communications device according to claim 35 wherein said clicks or pressure sequence may comprise one or more clicks on the LCD screen at one or more locations of said screen, thereby enabling a user to set a particular button sequence to navigate a particular feature path.

37. A communications device according to claim 36 wherein the number of clicks for a particular operation may be adjusted via a fast click option in set up software.

38. A communications device according to claim 1 wherein the device is capable of communications with a like device.

39. An electronic hand held communications and data storage device capable of sending and receiving preset data to and from another remote source device, wherein said communication device includes;
an input/output port,
an LCD display for displaying said data,
means for sending said preset data to said remote device,
characterized in that the LCD screen includes at least one operating station allowing a user to read and navigate through available data paths initiated via a menu and independently process, down load upload or otherwise manipulate said data displayed on the screen via the operating stations.

40. A method for operating an electronic hand held communications and data storage device capable of sending and receiving preset data to and from another remote source device, the hand held device including an LCD display for displaying said data,
the method comprising the step of;
applying mechanical manual action to said LCD display in a predetermined sequence and in at least one predetermined location on the display to navigate through data paths and manipulate data via a menu on the screen display;
wherein said communication device includes;
an input/output port;
means for sending said preset data to said remote device;
wherein the operator may read data on the screen and process, down load, upload or otherwise manipulate said data by applying said pressure in a predetermined sequence to said LCD display.

41. A method for operating an electronic hand held communication and data storage device capable of sending and receiving preset data to and from another remote source device, the hand held device including an LCD display for displaying said data,
the method comprising the steps of;
a) setting via enabling software, a predetermined number of navigational clicks for a particular operation thereby enabling a user to set a particular click sequence or shortcut to navigate a particular feature path,
b) applying pressure to said LCD display in a predetermined sequence and in at least one predetermined location on the display to navigate through data paths and manipulate data via a menu on the screen display;
wherein said communication device includes;
an input/output port;
means for sending said preset data to said remote device;
wherein the operator may read data on the screen, down load, upload or otherwise manipulate said data by applying said pressure to said LCD display.

42. A communications device according to claim 1 wherein the device communicates via bluetooth.

43. A communications device according to claim 1 wherein a user operation of the device via the display simulates a rocker or toggle switch.

44. A communications device according to claim 1, wherein the device further comprises means for global positioning system (GPS) navigation.

45. A communications device according to claim 1 wherein the physical size of the device is about 40 mm across.
